(19) United States
(12) Patent Application Publication
(10) Pub. No.: US 2026/0138906 A1
(43) Pub. Date: May 21, 2026

(54) WASTE HEAT RECOVERY SYSTEM AND METHOD OF RECOVERING WASTE HEAT FROM A FURNACE

(71) Applicants: Hisashi Kobayashi, Tonawanda, NY (US); Chao Liang, Tonawanda, NY (US)

(72) Inventors: Hisashi Kobayashi, Tonawanda, NY (US); Chao Liang, Tonawanda, NY (US)

(21) Appl. No.: 19/338,568

(22) Filed: Sep. 24, 2025

Related U.S. Application Data
(60) Provisional application No. 63/721,845, filed on Nov. 18, 2024.
(60) Provisional application No. 63/786,681, filed on Apr. 10, 2025.

(51) Int. Cl. C03B 5/237; C03B 3/02; C03B 5/235; F27D 3/08; F27D 13/00; F27D 17/18

(52) U.S. Cl. CPC C03B 5/237; C03B 3/023; C03B 5/2353; F27D 3/08; F27D 13/00; F27D 17/18; C03B 2211/40

(57) ABSTRACT

Disclosed is a flue gas heat recovery system and method for a glass melting furnace. In a first stage, the sensible heat of the flue gas is reduced in a regenerator or by use of high electric energy input in a hybrid electric furnace. In a second stage, the flue gas is used in a heat transfer fluid heater to provide heat to a heat transfer fluid. In a third stage, the heat transfer fluid provides heat to a batch/cullet preheater (BCPH) to preheat batch and/or cullet in an indirect heat exchanger such as a screw heat exchanger.

### FIELD OF THE INVENTION

The invention generally relates to the reduction of fuel consumption and the associated carbon dioxide (CO2) emission from fuel fired furnaces by the recovery of flue gas waste energy. More particularly, the invention relates to a system for recovering flue gas waste energy for glass melting furnaces including a batch-cullet preheater.

### BACKGROUND OF THE INVENTION

High temperature fuel fired furnaces generate large amounts of waste heat in the hot flue gas coming out of the furnace at a high temperature of about 1300° C. to 1600° C. Waste heat recovery is a practical method to reduce the fuel consumption in the furnace and CO2 emission. Regenerators are widely used for fuel-air fired glass furnaces to recover a large portion of flue gas waste heat by preheating combustion air. Some of the air-fired regenerative glass furnaces are equipped with a batch-cullet preheater (BCPH) as a secondary heat recovery system to preheat batch and cullet for further heat recovery. For an air fired furnace with regenerators, hot flue gas from the furnace is typically cooled to about 400° C. to 600° C. in the air heating regenerators and the cooled flue gas from the regenerators is introduced into a BCPH with or without air dilution/cooling. Since the flue gas volume flow rate is large, the piping and BCPH size is required to be very large.

Most oxy-fuel fired glass furnaces do not use flue gas heat recovery systems as the flue gas volume is much lower than that of air-fuel fired furnaces. However, the hot flue gas from the furnace is cooled by cooling air injection to 200° C. to 400° C. for the downstream air pollution control system (APCS). Since the cooling air flow requirement in Nm3/h is typically more than four times that of the flue gas volume flow rate in Nm3/h, the size of the APCS becomes very large due to cooling air injection. Several oxy-fuel fired furnaces have adopted Cullet Preheater (CPH) heat recovery systems as the primary waste heat recovery system. Fuel reduction in the furnace of 10 to 15% have been reported by this method of heat recovery. Hot flue gas from the furnace at a temperature of about 1400° C. to 1500° C. is modulated in temperature to about 400-500° C. by mixing with a cooled flue gas stream recycled from CPH and the diluted gas stream is introduced into CPH. As a result of this temperature modulation requirement the flue gas volume flow rate becomes very large and the piping and BCPH size becomes very large. The large equipment size often made it difficult to retrofit a BCPH in an existing plant, and the resulting high installation cost of these BCPHs and CPHs are currently limiting the adoption of these heat recovery systems. Several other oxy-fuel fired furnaces have adopted oxygen and natural gas preheating as the primary waste heat recovery system. Metallic recuperators are used to preheat oxygen up to 600° C. and natural gas up to 450° C. Fuel reduction in the furnace of 8 to 12% have been reported by this method of heat recovery.

Thermochemical regenerators (TCR) (U.S. Pat. No. 6,113,874) were developed to recover a large portion of waste heat in the flue gas from oxy-fuel fired furnaces. Heat transferred from hot flue gas and stored in a checker pack in a regenerator chamber is recovered by heating and reforming a mixture of natural gas and the cooled recycled flue gas (RFG) that is recycled by a fan, noted as RFG fan, from the other regenerator chamber. The endothermic reforming reactions form syngas containing hydrogen, carbon monoxide, soot, residual methane and flue gas components. Fuel reduction in the furnace of 13 to 16% have been reported by this method of heat recovery. Flue gas exiting TCR generally has a temperature of about 500° C. to 750° C. and still has a significant waste heat that can be recovered by a secondary waste heat recovery unit. In the current operation of a glass furnace with TCR, the cooled flue gas from TCR is further cooled down by mixing with cooling air before further treatment in APCS such as a baghouse or an electrostatic precipitator, and no additional heat is recovered.

There are different types of batch/cullet preheaters (BCPH) in the prior art. They include both direct contact and indirect contact moving bed BCPHs and rotary kiln BCPHs. If both batch and cullet are preheated to 400° C. to 500° C. by the flue gas from an oxy-fuel fired glass furnace, fuel savings in the furnace of 20 to 25% are feasible. However, there are several technical difficulties in achieving such a high fuel savings in a single stage BCPH. Cullet ratios greater than 50% are typically required to prevent plugging in a moving bed BCPH system. Since cullet typically contains organic contaminants, organic fume and odor are generated when cullet is heated above 200° C. The flue gas containing organic fume from the BCPH needs to be treated downstream of the preheater, which adds additional cost and complexity to the BCPH operation. Batch particles are prone to agglomeration and plugging of batch/cullet flow passages in moving bed BCPHs. In a direct contact BCPH a large volume of hot flue gas flows over a large contact surface area of batch materials containing particles having a particle diameter of less than 200 microns. To prevent particle carryover into the flue gas stream the gas velocity is typically controlled to less than 10 m/s. To mitigate this carryover risk, the gas flow passages are widely spaced which results in very large and costly equipment. For example, a moving bed BCPH unit installed in a 300 tpd container furnace had approximate external dimensions of 5 m wide×2.7 m deep, and 17 m high. The weight of the batch and cullet materials in the preheater was about 300 tons, or a material residence time of about one day. Such a large size unit is difficult to install in most existing glass plants due to space constraints.

For a direct contact rotary kiln BCPH, batch and cullet materials are well mixed with the hot flue gas, but a large amount of small particulates are carried into the exhaust flue gas, which needs to be captured and recycled. For the rotary shell and tube indirect contact BCPH (ref. U.S. Pat. No. 12,084,375 B2, EP 4,129,935 A3), the constant rotation helps the batch/cullet constantly contact with the shell and tubes where flue gas is flowing, and individual grains of batch/cullet are mixed several times for each rotation of the shell. However, many large tubes are required to pass through the large flow rate of flue gas to provide sufficient heat transfer surface area and the size of the BCPH becomes very large.

Another method to reduce CO2 emissions is to replace a portion of the furnace fuel energy requirement with electric energy. Electric boosting is used in many container furnaces and typically provides 5 to 10% of the furnace energy requirement. Hybrid fuel-electric glass melting furnaces have been developed recently to replace as much as 80% of the furnace fuel requirement with electric energy to reduce CO2 emissions. The flow rate and waste heat in the flue gas is reduced substantially in a hybrid furnace. Although the reduction of the combustion generated flue gas is proportional to the fuel reduction, the overall reduction of the flue gas flow rate is smaller due to other gases generated or entering into the furnace. They include water vapor generated from the moisture in batch and cullet materials, CO2 from thermal decomposition of batch ingredients such as soda ash and limestone, and ambient air infiltration into the furnace.

There remains a need to recover waste heat from flue gas with a compact heat recovery system that can be retrofitted into the existing glass plant in order to reduce fuel consumption and CO2 emissions from high temperature fuel fired furnaces.

### SUMMARY OF THE INVENTION

One aspect of the invention is a flue gas heat recovery system including a regenerator configured to receive a flue gas from a glass melting furnace and recover heat from the flue gas; a heat transfer fluid heater configured to receive flue gas from the regenerator, receive a heat transfer fluid, and transfer heat from the flue gas to the heat transfer fluid; and a batch/cullet preheater configured to receive the heat transfer fluid from the heat transfer fluid heater, to receive batch and/or cullet, to transfer heat by indirect heat exchange from the heat transfer fluid to the batch and/or cullet; and to recirculate the heat transfer fluid to the heat transfer fluid heater; wherein the glass melting furnace is configured to receive the batch and/or cullet from the batch/cullet preheater.

In other alternative aspects of the invention, the glass melting furnace is configured to receive fuel and an oxidant containing greater than 80% oxygen; the regenerator is configured to reduce the sensible heat of the flue gas to less than 0.5 GJ per ton of glass produced in the furnace; the batch/cullet preheater is, for example, a screw heat exchanger; the heat transfer fluid is thermal oil; and/or the regenerator is a thermochemical regenerator.

In another alternative aspect of the invention, the heat transfer fluid heater has a flue gas outlet for flue gas exiting the heat transfer fluid heater, wherein the batch/cullet preheater has a head space configured to receive a portion of flue gas from the flue gas outlet of the heat transfer fluid heater to provide heat and to increase the temperature of water vapor evaporated from the batch and/or cullet, and wherein the batch/cullet preheater is configured to return the flue gas after providing heat to the head space of the batch/cullet preheater to the flue gas exiting the flue gas outlet.

In another alternative aspect of the invention, the heat transfer fluid is water and the heat transfer fluid heater is configured to produce steam from the transfer of heat from the flue gas to the water, and the batch/cullet preheater is configured to receive the steam from the heat transfer fluid heater to transfer heat to the batch and/or cullet, condense the steam to water upon the transfer of heat to the batch and/or cullet, and recirculate the water to the heat transfer fluid heater. In an alternative embodiment, the regenerator is a thermochemical regenerator, and the heat transfer fluid heater is configured to provide steam to the thermochemical regenerator.

In another alternative aspect of the invention, the batch/cullet preheater has a head space configured to receive a first portion of the flue gas from the regenerator to provide heat, and the heat transfer fluid heater is configured to receive a second portion of the flue gas from the regenerator, and the batch/cullet preheater is configured to recycle the first portion of the flue gas after providing heat to the head space of the batch/cullet preheater to the regenerator. Alternatively, the batch/cullet preheater is configured to direct the first portion of the flue gas after providing heat to the head space of the batch/cullet preheater to combine with the flue gas exiting the flue gas outlet of the heat transfer fluid heater. In an alternative aspect, the first portion of the flue gas from the regenerator is 5 to 40% of the flue gas from the regenerator, and the second portion of the flue gas is 60 to 95% of the flue gas from the regenerator.

In another alternative embodiment, the heat transfer fluid heater includes a first zone configured to produce a lower temperature heat transfer fluid and a second zone configured to produce a higher temperature heat transfer fluid, and wherein the batch/cullet preheater is a two-stage batch/cullet preheater including a first batch/cullet preheater configured to receive the lower temperature heat transfer fluid from the first zone of the heat transfer fluid heater, and a second batch/cullet preheater configured to receive the higher temperature heat transfer fluid from the second zone of the heat transfer fluid heater.

In a second aspect of the invention is a method of recovering heat from a flue gas, including: (A) recovering heat from a flue gas from a glass melting furnace in a regenerator for reducing the temperature of the flue gas; (B) transferring heat from flue gas from the regenerator to a heat transfer fluid in a heat transfer fluid heater; (C) heating a batch and/or cullet in a batch/cullet preheater by indirect heat exchange using the heat transfer fluid from the heat transfer fluid heater; (D) recirculating the heat transfer fluid from the batch/cullet preheater to the heat transfer fluid heater; and (E) feeding the batch and/or cullet from the batch/cullet preheater to the glass melting furnace.

A third aspect of the invention is a flue gas heat recovery system including a glass melting furnace configured to provide heat by combustion of a fuel and by electric energy to melt glass, and configured to produce a flue gas having a sensible heat of less than 0.5 GJ per ton of the glass produced, a heat transfer fluid heater configured to receive flue gas from the glass melting furnace, receive a heat transfer fluid, and transfer heat from the flue gas to the heat transfer fluid; and a batch/cullet preheater configured to receive the heat transfer fluid from the heat transfer fluid heater, to receive batch and/or cullet, to transfer heat by indirect heat exchange from the heat transfer fluid to the batch and/or cullet; and to recirculate the heat transfer fluid to the heat transfer fluid heater; wherein the glass melting furnace is configured to receive the batch and/or cullet from the batch/cullet preheater.

In an alternative aspect of the invention, the glass melting furnace is configured to receive an input of electric energy of 40% or more of the total energy input to the glass melting furnace, wherein the total energy input is the sum of a lower heating value of the fuel input and the electric energy input.

In another alternative embodiment, the batch/cullet preheater has a head space with a batch/cullet preheater flue gas inlet configured to receive a first portion of flue gas from the glass melting furnace to provide heat, and the heat transfer fluid heater is configured to receive a second portion of flue gas from the glass melting furnace, the heat transfer fluid heater has a flue gas outlet for flue gas to exit the heat transfer fluid heater, the batch/cullet preheater has a flue gas outlet for flue gas to exit after providing heat to the head space, and the batch/cullet preheater is configured to recycle a portion of the flue gas from the batch/cullet preheater flue gas outlet to the batch/cullet preheater flue gas inlet and direct another portion of the flue gas from the batch/cullet preheater flue gas outlet to combine with the flue gas exiting the flue gas outlet of the heat transfer fluid heater. In alternative embodiment, the first portion of the flue gas from the glass melting furnace is 5 to 20% of the flue gas from the glass melting furnace, and the second portion of the flue gas is 80 to 95% of the flue gas from the flue gas melting furnace.

A fourth aspect of the invention is a method of recovering heat from a flue gas including: (A) melting glass in a glass melting furnace using heat from combustion of fuel and electric energy, and producing a flue gas having a sensible heat of less than 0.5 GJ per ton of the glass melted; (B) transferring heat from flue gas from the glass melting furnace to a heat transfer fluid in a heat transfer fluid heater; (C) heating a batch and/or cullet in a batch/cullet preheater by indirect heat exchange using the heat transfer fluid from the heat transfer fluid heater; (D) recirculating the heat transfer fluid from the batch/cullet preheater to the heat transfer fluid heater; and (E) feeding the batch and/or cullet from the batch/cullet preheater to the glass melting furnace.

### BRIEF DESCRIPTION OF THE DRAWINGS

FIG. 1 is a flow diagram showing an embodiment of the flue gas heat recovery system using a thermal oil heater.

FIG. 2 is a flow diagram showing another embodiment of the flue gas heat recovery system using a steam boiler.

FIG. 3 is a flow diagram showing an alternative embodiment in which steam from the steam boiler may be fed to the thermochemical regenerator.

FIG. 4 is a flow diagram showing an alternative embodiment in which flue gas from the thermal oil heater may be used in the headspace of the screw heat exchanger.

FIG. 5 is a flow diagram showing an embodiment using a hybrid furnace and a thermal oil heater.

FIG. 6 is a flow diagram showing an alternative embodiment using a hybrid furnace and a thermal oil heater, and in which flue gas from thermal oil heater may be used in the headspace of the screw heat exchanger.

FIG. 7 is a flow diagram showing an alternative embodiment using a hybrid furnace and a steam boiler.

FIG. 8 is a flow diagram showing an alternative embodiment using a hybrid furnace and a steam boiler, and in which flue gas from the steam boiler may be used in the headspace of the screw heat exchanger.

FIG. 9 is a flow diagram showing an alternative embodiment in which steam from the steam boiler may be fed to the thermochemical regenerator, and in which flue gas from the steam boiler may be used in the headspace of the screw heat exchanger.

FIG. 10 is a flow diagram showing an alternative embodiment of the flue gas heat recovery system in which a portion of the flue gas from a regenerator is used for direct heating of batch and/or cullet and using a thermal oil heater for indirect heating of batch and/or cullet.

FIG. 11 is a flow diagram showing an alternative embodiment of the flue gas heat recovery system in which a portion of the flue gas from a regenerator is used for direct heating of batch and/or cullet and a thermal oil heater is used for indirect heating of batch and/or cullet, and in which the cooled flue gas from the batch/cullet preheater is recycled to the regenerator.

FIG. 12 is a flow diagram showing an alternative embodiment of the flue gas heat recovery system in which a portion of the flue gas from a regenerator is used for direct heating of batch and/or cullet and a steam boiler is used for indirect heating of batch and/or cullet.

FIG. 13 is a flow diagram showing an alternative embodiment of the flue gas heat recovery system in which a portion of the flue gas from a regenerator is used for direct heating of batch and/or cullet and a steam boiler is used for indirect heating of batch and/or cullet, and in which the cooled flue gas from the batch/cullet preheater is recycled to the regenerator.

FIG. 14 is a flow diagram showing an alternative embodiment of the flue gas heat recovery system in which a portion of the flue gas from a hybrid furnace is used for direct heating of batch and/or cullet and a thermal oil heater is used for indirect heating of batch and/or cullet.

FIG. 15 is a flow diagram showing an alternative embodiment of the flue gas heat recovery system in which a portion of the flue gas from a hybrid furnace is used for direct heating of batch and/or cullet and a steam boiler is used for indirect heating of batch and/or cullet.

### DETAILED DESCRIPTION OF THE INVENTION

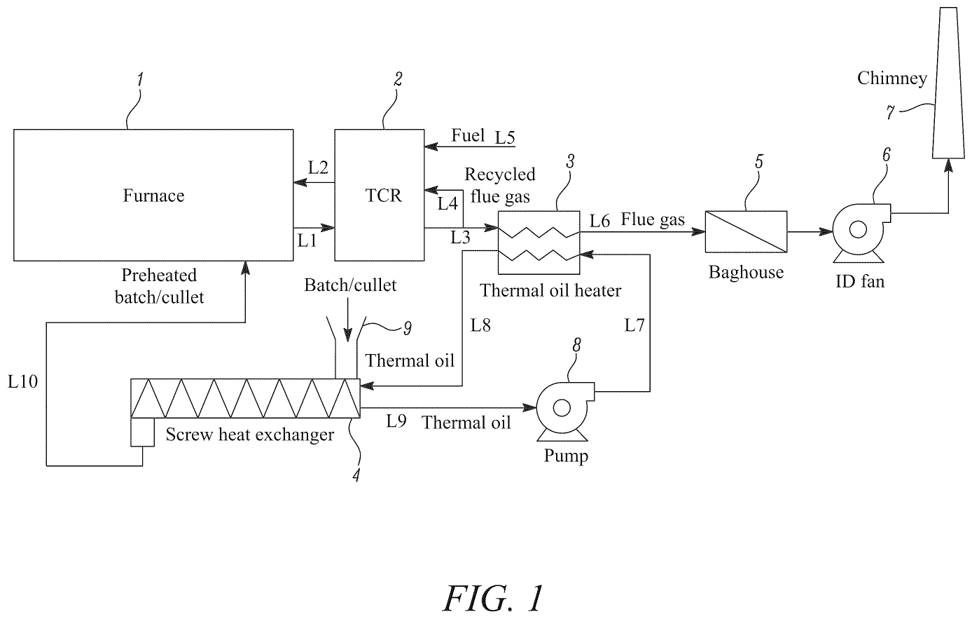

An embodiment of the invention employs a three-stage flue gas heat recovery system and method for a glass melting furnace. The three-stage heat recovery system allows for “full heat recovery” from the glass furnace flue gas. Full heat recovery is considered as taking place when the flue gas temperature is reduced to 200° C. to 400° C. after heat recover. The three-stage flue gas heat recovery system depicted in FIGS. 1 to 4 includes (1) Regenerators (air heating or TCR), (2) Heat transfer fluid heater and (3) BCPH in series. The glass melting furnace is fired with fuel and an oxidant. The oxidant preferably contains 80 to 100%, more preferably 90 to 100%, oxygen. In the first stage, the hot flue gas from the furnace is first introduced into the regenerators to recover flue gas sensible heat as preheated air or as preheated syngas. The flue gas from the furnace is cooled from a range of about 1300° C. to about 1600° C. down to about 500° C. to about 750° C. in the first stage. The second stage heat transfer fluid heater is an indirect heat exchanger in which a clean heat transfer fluid such as thermal oil or steam is heated to about 200° C. to about 350° C. and the flue gas from the TCR is further cooled to about 180° C. to about 400° C. The third stage BCPH is an indirect heat exchanger in which the clean heat transfer fluid from the second stage heat exchanger is used to dry and heat the furnace charge (batch and cullet) to about 100° C. to about 250° C. The dry heated charge materials are then introduced into the furnace for melting. Energy balance calculations predict about 25% total fuel reduction by employing this three-stage heat recovery system and method to reduce the flue gas temperature to 200° C. to 400° C. required for the APCS. In this “full heat recovery” operation air injection cooling of flue gas is eliminated.

In general heat exchanger equipment requires a larger heat transfer area when the temperature difference between the hot medium and the cold medium becomes smaller. Using an intermediate heat transfer fluid to transfer heat from the hot flue gas to the cold batch and cullet in two stages (i.e., stage 2 and stage 3 above) is considered inefficient in the conventional engineering practice. The temperature difference between the hot flue gas to the heat transfer fluid and that between the heat transfer fluid to the batch and cullet both become roughly ½ of the temperature difference available between the hot flue gas and the cold batch and cullet. Also, the cold batch and cullet cannot be heated to more than the temperature of the heat transfer fluid, limiting the maximum preheat temperature. Contrary to the conventional wisdom, the inventors found that the unique combination of the three-stage heat recovery system provides efficient indirect heat exchanges both between the hot flue gas and the heat transfer fluid and between the heat transfer fluid and the batch and cullet. The BCPH equipment size is reduced as compared with the conventional equipment. Efficient heat transfer by using an intermediate heat transfer fluid is feasible because a modest preheat temperature of batch and cullet to less than 250° C. is sufficient to fully recover waste heat in the flue gas in the three-stage heat recovery system.

In the stage 2 heat transfer fluid heater with hot flue gas, the use of clean heat transfer fluid reduces the heat exchanger size and also enables the use of a compact indirect BCPH in stage 3. Preferred clean fluids are thermal oil used in a thermal oil heater (TOH) and water/steam used in steam boiler (SB). The use of thermal oil and steam for heat transfer reduces the piping size and the installation costs.

In a preferred embodiment, an indirect heat exchanger is used for the BCPH in stage 3 to dry and preheat batch and cullet by a heat transfer fluid. The indirect heat exchanger may be a screw heat exchanger (SHX) in which heat transfer fluid circulates through hollow screws and the casing. The screw heat exchanger may be, for example, a screw conveyor heat exchanger, a thermal screw conveyor, a heat transfer screw conveyor, a thermal screw processor, etc. Screw heat exchangers provide heating or cooling of solid materials while simultaneously conveying them using rotating screws in an enclosure. SHX provides efficient indirect heat exchange between solid charge materials and a clean heat transfer fluid flowing through a center shaft tube, a jacketed trough, a hollow screw flight, or all three depending on required thermal duty. In a preferred design the clean heat transfer fluid flows through all of these three components mentioned above.

The indirect heat exchanger also preferably has a head space to provide supplemental direct heating in the head space. For example, an SHX may have a head space which can provide direct heating using a portion of the hot flue gas from the furnace, or the regenerator or the heat transfer fluid heater. The size of SHX is significantly smaller than a conventional BCPH used in a glass plant that is heated by a large volume of flue gas.

The supplemental direct heating by a portion of the flue gas in the head space of SHX provides additional heating of batch and cullet, and prevents condensation of water vapor from batch and cullet by increasing the gas temperature. By limiting the amount of the gas flow and velocity over the batch and cullet in the head space the carryover of fine particles normally associated with the direct contact hot gas heating system is controlled. The cooled flue gas from SHX is optionally recirculated to the furnace through the TCR after mixing with fuel for heat recovery. Potential emission of organic fume and odor from preheated cullet is eliminated by incineration in the furnace. Alternatively, the flue gas may be treated in a baghouse and exhausted through a chimney with an induced draft fan.

In spite of the size and efficiency advantage, SHX has not before been used as BCPH in glass plants due in part to its limitation on the maximum preheat temperature. Since the maximum temperature of heat transfer fluids used for heating applications is 200° C. to 350° C., the practical maximum BCPH temperature achievable is considered about 250° C. The amount of waste heat transferred to batch and cullet is limited compared to the prior art BCPHs that can preheat batch and cullet to as high as 450° C. The inventors found that by reducing the flue gas heat recovery requirement, SHX offers a retrofittable option as a BCPH for glass melting furnaces.

With SHX used for BCPH, batch/cullet is conveyed by rotating screws rather than relying on a gravity fed moving bed as in the prior art preheater. Mechanically controlled movement of screws prevent plugging of the batch/cullet flow passages by agglomeration. The new system is more compact, at a lower cost, and less complex to operate, than the prior art BCPH system which uses a large volume of hot flue gas as the heat transfer medium.

Depending on the flue gas temperature after the secondary heat recovery system, downstream cooling air normally required before an air pollution control system is reduced or eliminated. Flue gas temperature is typically cooled for the downstream pollution control system to 180° C. to 200° C. for a bag house and 300° C. to 400° C. for an electrostatic precipitator to control particulates emission. By cooling the hot flue gas in the subject heat recovery system, the volume flow rate of the flue gas is reduced, and the downstream pollution control equipment size is reduced.

The use of indirect SHX for the BCPH prevents the risks of plugging of batch/cullet flow passages due to agglomeration. The dust/organic fume/odor entrainment into the flue gas encountered with moving bed type direct contact BCPHs is controlled by using a portion of hot flue gas in the head space. SHX used as BCPH enhances the heat transfer by utilizing all of the screw surface area for indirect heat transfer and the supplemental direct heating by hot flue gas in the head space above batch and cullet. This enhancement of heat transfer area allows for more compact equipment design. The clean heat transfer fluid used in the third stage BCPH offers an important maintenance advantage as compared with using the hot flue gas directly. Dust particulates in the flue gas are known to form a deposit layer on pipes and heat transfer surfaces. The deposit layer formed on the heat transfer surfaces needs to be removed at a regular interval to maintain good heat transfer, which interrupts the continuous operation of the BCPH system and increases the maintenance cost. In the present invention a small flow rate of hot flue gas is optionally introduced in the head space to provide additional heat and to prevent the condensation of water vapor, which reduces the buildup of the dust deposit layer. Moreover, rotating screws make batch/cullet continuously scrape the screws, which also helps to mitigate the build-up of the dust deposit layer formed on the heat transfer surface.

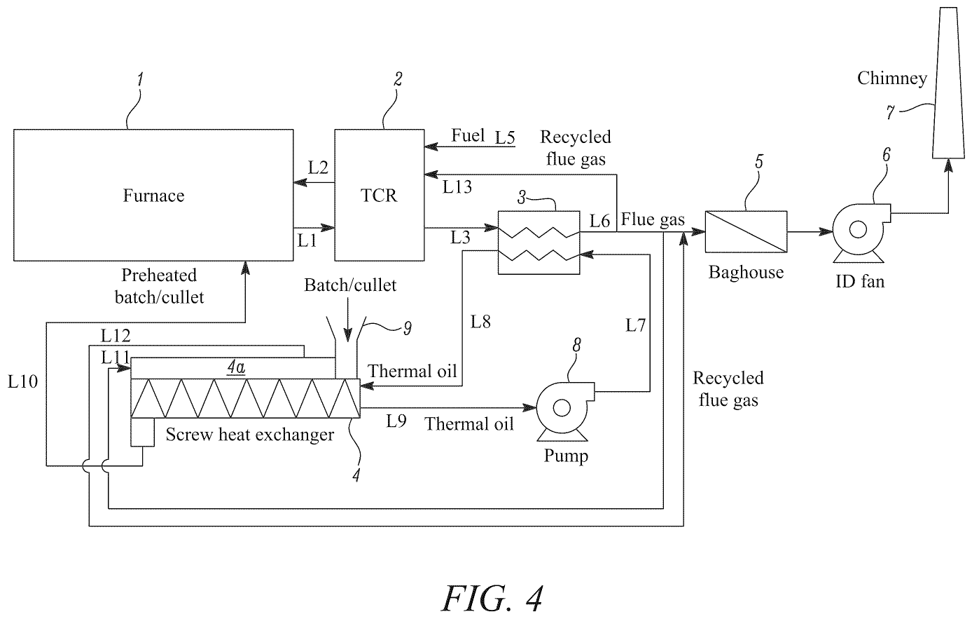

An embodiment of the heat recovery system includes (1) a TCR, (2) a heat transfer fluid heater, and (3) a batch/cullet pre-heater (BCPH). FIG. 1 illustrates a First Embodiment of a three-stage flue gas heat recovery system. In the embodiment shown in FIG. 1, the heat transfer fluid heater is a thermal oil heater (TOH) and the BCPH is preferably a screw heat exchanger (SHX) 4. The heat recovery system as shown in FIG. 1 includes TCR 2, thermal oil heater (TOH) 3 and SHX 4 in series. TCR 2 consist of two separate heat transfer chambers one receiving flue gas L1 from furnace 1 and another one receiving fuel L5 and recycled flue gas L4 (alternatively recycled flue gas L13 can be received from the heat transfer fluid heater 3 as shown in FIG. 4). The heat transfer roles of two separate heat storage chambers are alternated in a cyclical fashion.

The flue gas exits the furnace 1 and enters TCR 2 in line L1. Products from TCR 2 are fed to furnace 1 in line L2. Cooled flue gas from TCR 2 enters thermal oil heater 3 in line L3. Fuel is also fed to TCR 2 in line L5. Flue gas exits thermal oil heater 3 in line L6 for further cooling/treatment in baghouse 5 before being exhausted through chimney 7 with an induced draft fan 6. Some flue gas may be recycled back to TCR 2 in line L4. Alternatively, or in addition to flue gas recycle line L4, flue gas may be recycled to TCR 2 from flue gas line L6 exiting thermal oil heater 3.

Thermal oil in line L7 enters thermal oil heater 3 which is heated by heat exchange with the flue gas. Thermal oil exiting the thermal oil heater 3 in line L8 enters SHX 4 for pre-heating the batch/cullet. After heat exchanging with the batch/cullet, the thermal oil exits SHX 4 in line L9 to be pumped back to thermal oil heater 3 with pump 8 via line L7. Although not shown in the figure an expansion tank and an optional drain tank are connected in the thermal oil circuit. The oil drain tank is used to drain the thermal oil to service the TOH 3 and SHX 4. Batch/Cullet enters SHX 4 via the batch/cullet feeder 9. Pre-heated batch/cullet exits SHX 4 via line L10 and enters furnace 1.

Furnace 1 is preferably fired with an oxidant containing 80 to 100% oxygen. Flue gas exiting TCR 2 in line L3 has a temperature of about 500° C. to about 750° C. and the sensible heat of the flue gas is less than about 0.5 GJ/t, preferably less than about 0.4 GJ/t, more preferably less than about 0.3 GJ/t. And the sensible heat of the flue gas is greater than about 0.1 GJ/t, preferably greater than about 0.2 GJ/t. Thermal oil heater 3 is placed downstream of TCR 2 which further cools the flue gas to about 180° C. to about 400° C. and heats the thermal oil from 150° C. up to about 350° C., preferably from about 200° C. to about 300° C. Thermal oil heater 3 may be of conventional design with serpentine tubes, caged tubes or spiral wound coils for thermal oil passages placed in one or more hot flue gas ducts connected to TCR 2. The heated thermal oil then flows through SHX 4 to dry and heat batch/cullet from ambient temperature to above 120° C., preferably above 150° C., more preferably above 200° C. The dried and preheated batch/cullet is fed into the furnace 1 by chargers. The cooled thermal oil returned from SHX 4 is pumped back to the thermal oil heater 3 at a pressure that is higher than the vapor pressure at the operating temperature of the thermal oil.

In an alternative embodiment, the system may include a two-stage screw heat exchanger having two separate oil circulation loops of different temperatures. In the first stage, a first SHX dries and heats batch/cullet to about 120° C. with lower temperature thermal oil of, for example, less than about 200° C. In a second stage, a second SHX superheats the heated batch/cullet from the first stage SHX to above about 150° C. with higher temperature thermal oil of greater than about 250° C. In this alternative embodiment, the thermal oil heater has two zones, a high temperature zone and a low temperature zone, to enable a greater heat recovery to cool down flue gas below 250° C. by heating the higher temperature thermal oil in the high temperature zone and heating the lower temperature thermal oil in the low temperature zone.

In another embodiment, the second stage TOH has spiral wound coils or in-line or staggered tubes with a circulating heat transfer fluid inside placed in one or more flue gas passages downstream of a TCR. Optionally, the coils/tubes may be placed inside the TCR casing, for example, below the checkers. The TOH is used to heat the thermal oil as the heat transfer fluid and cools down the flue gas exiting the TCR. The heated thermal oil transfers its heat to batch and cullet in the SHX. Commercially available thermal oil that can be used, for example, are Therminol®, Texatherm®, Dowtherm®, Multitherm®, etc.

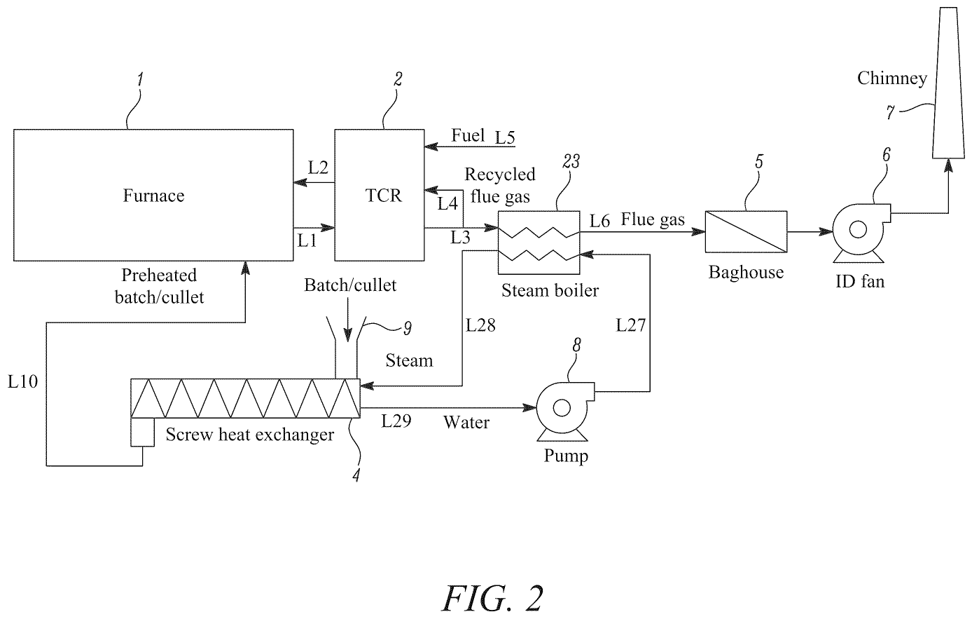

FIG. 2 illustrates a Second Embodiment of the invention. In this embodiment, the second stage heat transfer fluid heater is a steam boiler (SB) in which generated steam is used as the heating medium in the third stage SHX. The SB is used to generate steam and cool down flue gas from the TCR. The process in the embodiment illustrated in FIG. 2 is similar to the First Embodiment using thermal oil as heating medium shown in FIG. 1, except that a steam boiler (SB) 23 is placed downstream of TCR 2 instead of a thermal oil heater. Condensed water in line L27 enters SB 23 and is evaporated to steam at a temperature of about 150° C. to about 300° C., preferably about 180° C. to about 250° C. Steam exits the SB 23 in line L28 and flows to SHX 4 to dry and heat the batch/cullet from room temperature to about 120° C., preferably about 150° C., more preferably 200° C. or more. The steam condenses in SHX 4 and the steam condensate exits SHX 4 in line L29 to be recirculated to SB 23 via pump 8 at a pressure of about 5 bara to about 86 bara, preferably about 10 bara to about 40 bara. Although not shown in the figures, the water-steam lines are connected to other standard components such as a feed water line, a water softener, and a de-aerator, and SB 23 is connected to a flash tank (not shown).

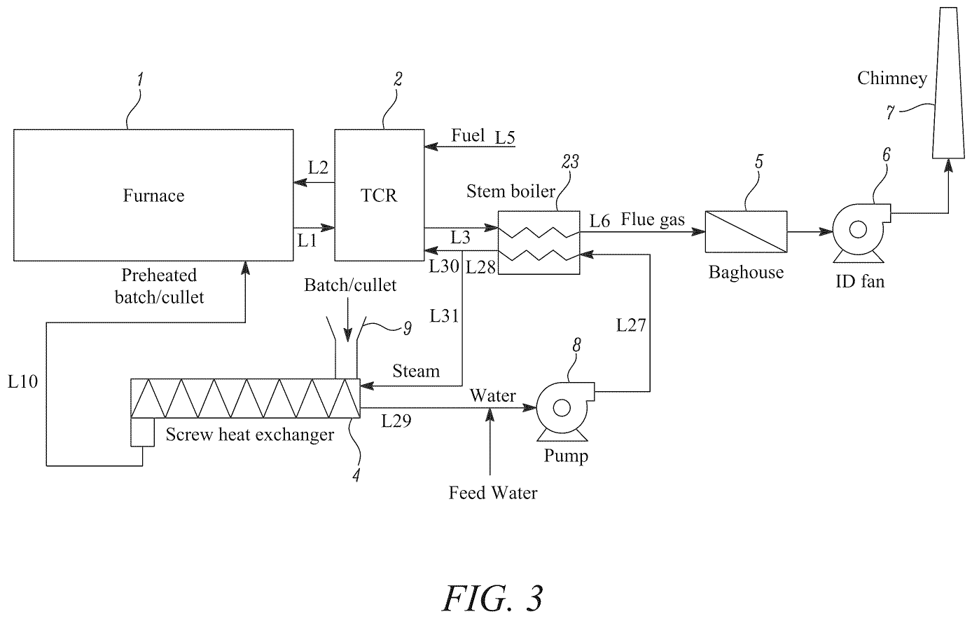

As another alternative embodiment, excess steam can be produced in SB 23 which can be used to partially or totally replace the recycled flue gas used in TCR 2. As illustrated in FIG. 3, steam exiting SB 23 in line L28 can be split into line L30 which flows to TCR 2 and line L31 which flows to SHX 4. In the embodiment shown in FIG. 3, there is no flue gas recycle stream and steam totally replaces the recycled flue gas. However, the system may include both a flue gas recycle stream and an excess steam feed to the TCR allowing for a combination of recycled flue gas from TCR 2 and steam from SB 23 to be fed to TCR 2.

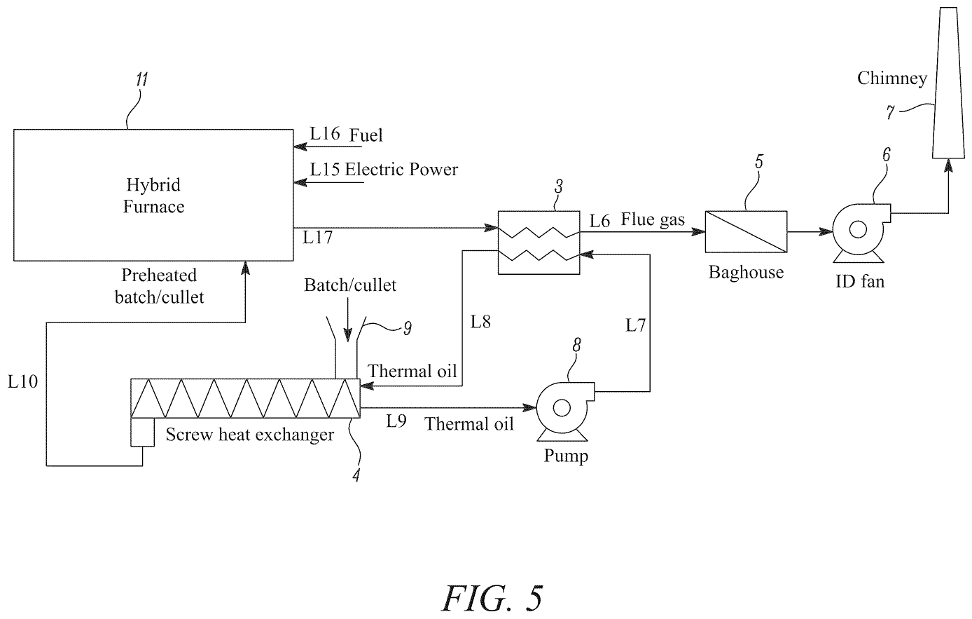

FIG. 5 illustrates a Third Embodiment which employs a hybrid furnace 11 in a three-stage flue gas heat recovery system. The heat recovery system includes (1) High electric energy input in the hybrid furnace, (2) Heat transfer fluid heater and (3) BCPH. The combination of high electric energy and fuel in stage one, and the two-stage heat exchanger system allows for full heat recovery from the glass furnace flue gas. In the first stage, the flue gas flow rate and the energy content of the hot flue gas from the furnace is reduced by replacing 30 to 80% of the fuel energy with electric energy. The temperature of the flue gas is reduced from about 1450° C. in a conventional oxy-fuel fired furnace to about 600° C. to about 1200° C. in a high electric hybrid oxy-fuel-electric furnace. The second stage heat transfer fluid heater is an indirect heat exchanger in which, a clean heat transfer fluid such as thermal oil or steam is heated to about 200° C. to about 350° C. and the flue gas from the furnace is cooled to about 180° C. to about 400° C. The clean heat transfer fluid from the second stage heat exchanger is used to dry and heat the furnace charge (batch and cullet) to about 100° C. to about 250° C. in a third indirect heat exchanger. The dry heated charge materials are then introduced into the furnace for melting. In the embodiment described above, stage 3 is BCPH. Energy balance calculations predict about 58% total fuel reduction by this three-stage heat recovery system and method to reduce the flue gas temperature to 200° C. to 400° C. required for the APCS. In this “full heat recovery” operation air injection cooling of flue gas is eliminated.

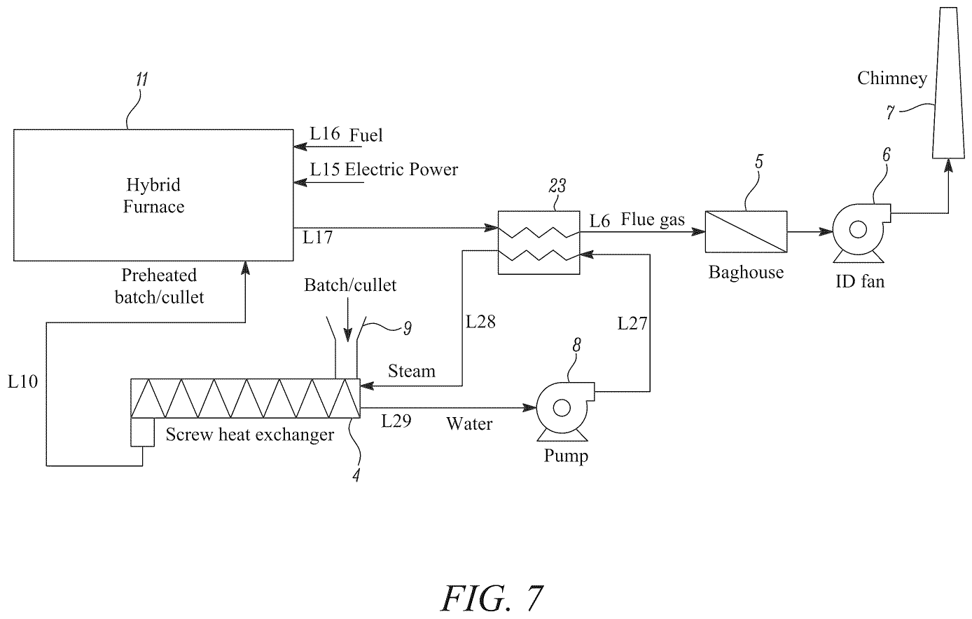

As illustrated in FIG. 5, the hybrid furnace 11 includes fuel line L16 and electric power input as represented by line L15. As described above, flue gas line L17 exiting the hybrid furnace 11 has a reduced flow rate and energy content due to the replacement of fuel energy with electric energy. The flue gas produced in the hybrid furnace shown as line L17 has a sensible heat of less than 0.5 GJ, preferably less than 0.4 GJ, and more preferably less than 0.3 GJ per ton of the glass melted in the furnace. The hot flue gas in line L17 from the hybrid furnace 11 feeds to thermal oil heater 3. An alternative method to control the gas temperature entering the thermal oil heater 3 is to recycle a portion of the cooled flue gas from thermal oil heater in line L6 back to the line L17 using a RFG fan. The flue gas in the thermal oil heater 3 heats the thermal oil by indirect heat exchange, and heated thermal oil in line L8 is fed to the SHX 4 to heat the batch and/or cullet in a similar manner as in the First embodiment. In an alternative embodiment, the thermal oil heater may be replaced with a steam boiler 23 as shown in FIG. 7.

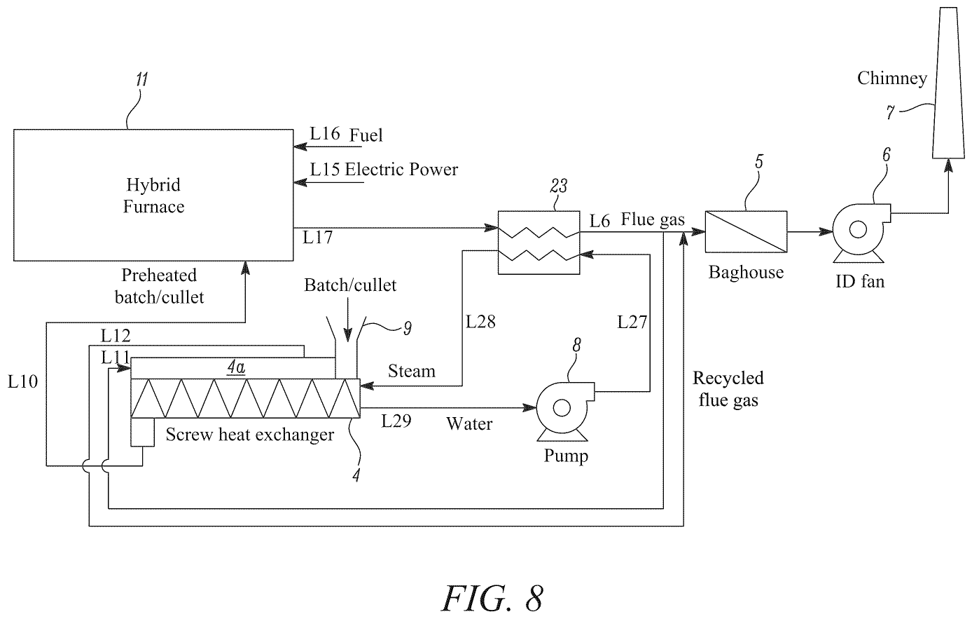

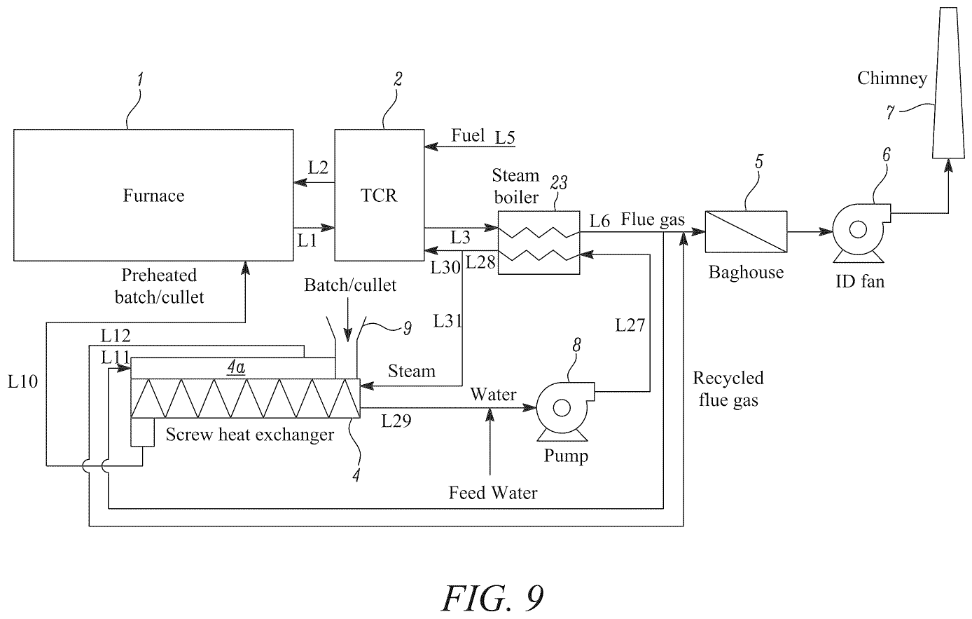

In another embodiment which may be applied to any of the previous embodiments described, a portion of the flue gas line L6 after the thermal oil heater 3 or the steam boiler 23 is introduced in the head space of the SHX to provide additional heat to the BCPH and to increase the temperature of water vapor evaporated from the batch-cullet mixture to prevent water or acid condensation in the outlet passage walls of the SHX. For example, FIGS. 4, 6, 8 and 9 show flue gas line L11 split from flue gas line L6 exiting the thermal oil heater 3. Flue gas line L11 enters head space 4a of SHX 4. After providing heat to the head space 4a, the flue gas that has been further cooled exits the head space 4a in line L12 to return to flue gas line L6. FIG. 4 further illustrates that flue gas from line L6 may be recycled back to TCR 2 in line L13. This optional flue gas recycle line L13 may be applied to any embodiment having a regenerator such as TCR 2.

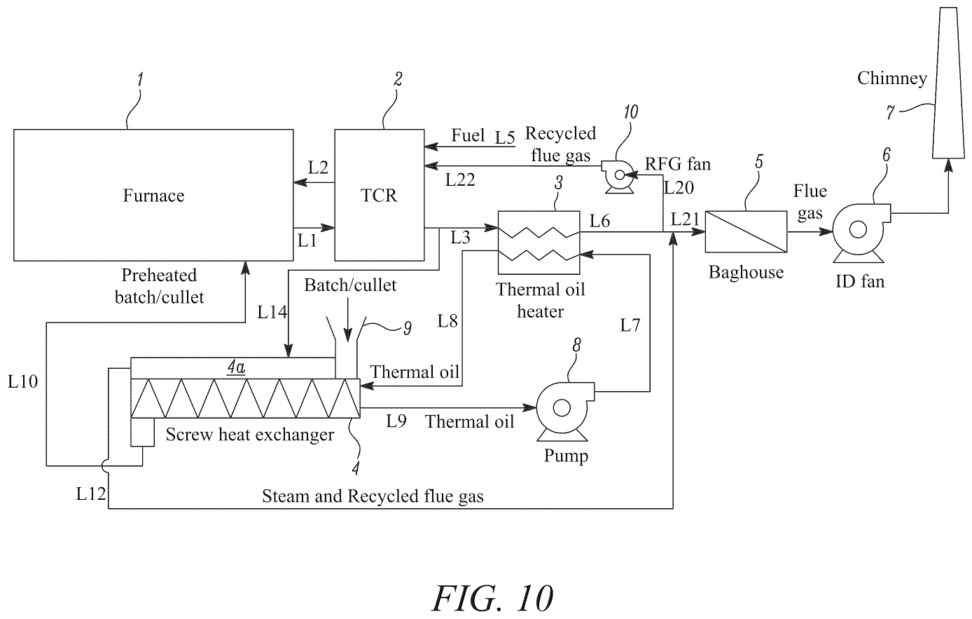

FIG. 10 illustrates another embodiment of a three-stage flue gas heat recovery system, similar in configuration to the embodiment shown in FIG. 4. The heat transfer fluid heater is a thermal oil heater (TOH) and the BCPH is preferably a screw heat exchanger (SHX). The flue gas exits the furnace 1 and enters TCR 2 in line L1. A range of 5 to 40%, preferably 10 to 20%, of the flue gas from TCR 2 is introduced in the head space 4a of the SHX in line L14 to provide additional heat to the batch and cullet in SHX 4 and to increase the temperature of water vapor evaporated from the batch-cullet mixture to prevent water or acid condensation in the outlet pipe in line L12. The maximum flow rate of the flue gas introduced into the head space is controlled to avoid particulate carry over. The remaining 60 to 95%, preferably 80 to 90%, of the cooled flue gas from TCR 2 enters TOH 3 in line L3. A range of 10 to 30% of the cooled flue gas from TOH is recycled back to TCR 2 as recycled flue gas (RFG) in lines L20 and L22 by the RFG fan 10. Fuel is also fed to TCR 2 in line L5. Products from TCR 2 are fed to furnace 1 in line L2. The flue gas from TOH 3 in line L6 is combined with the water vapor-flue gas mixture in line L12 from SHX head space 4a, after RFG is branched off in Line L20. The combined stream in Line 21 is treated in baghouse 5 and exhausted through chimney 7 with an induced draft fan 6.

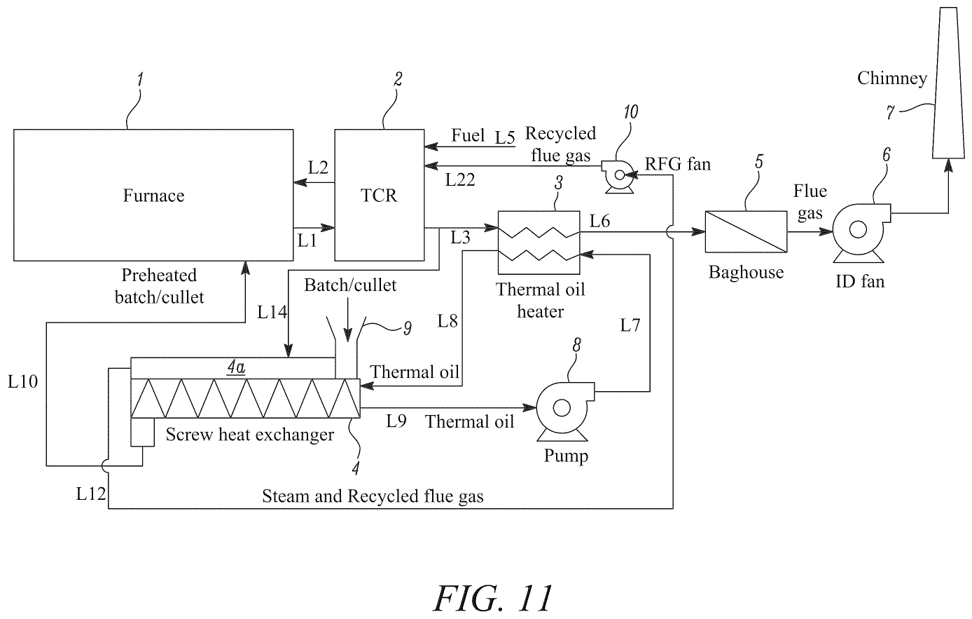

FIG. 11 illustrates an alternative embodiment of the invention shown in FIG. 10 in which the water vapor-flue gas mixture from SHX head space 4a is directly recycled back to TCR 2 in lines L12 and L22 by the RFG fan 10. This embodiment is especially beneficial when incineration of organic fume from BCPH is required to prevent emissions or odor problems.

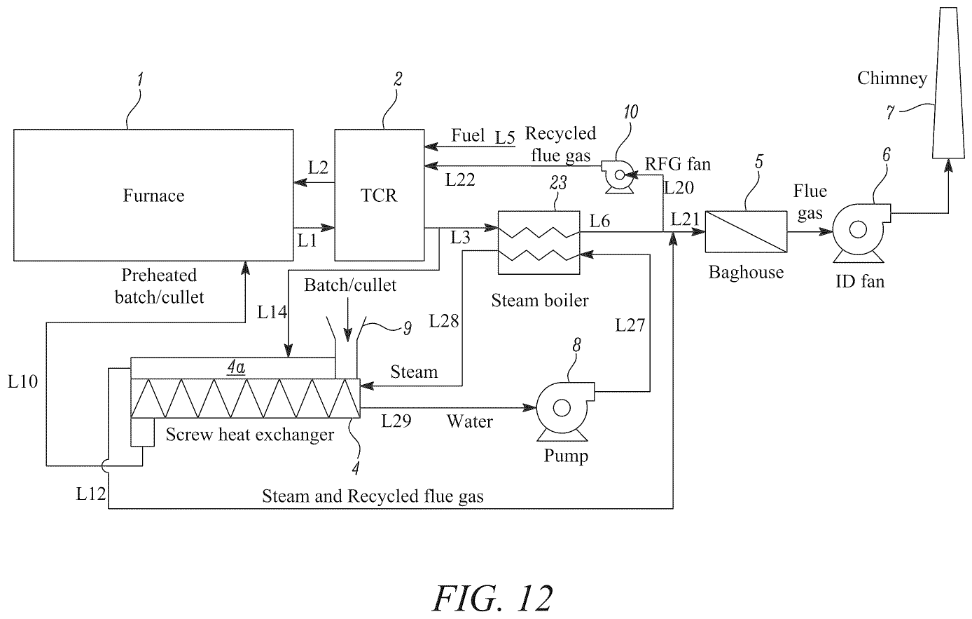

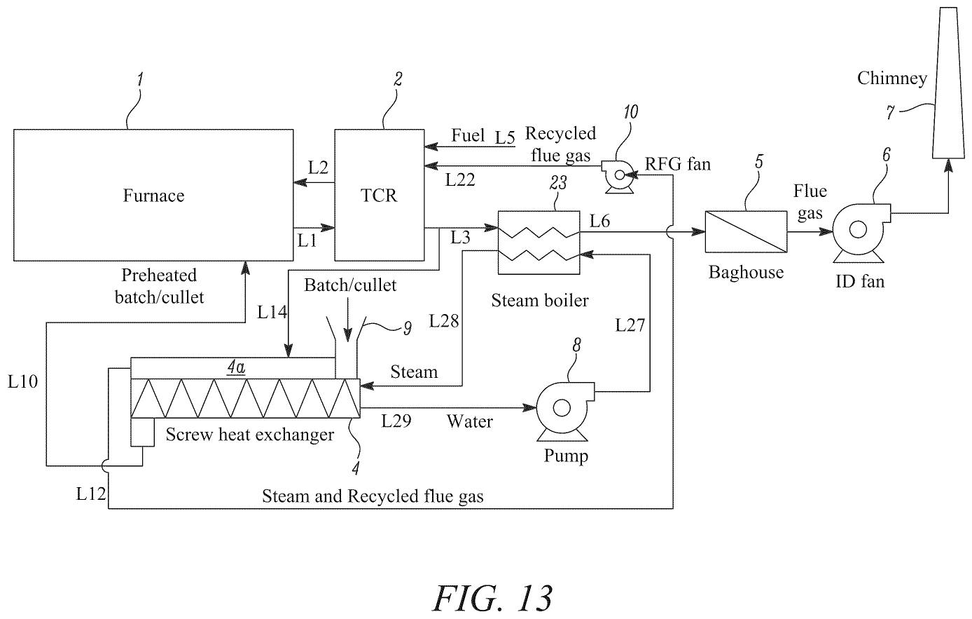

FIGS. 12 and 13 illustrate alternative embodiments of the invention shown in FIG. 10 and FIG. 11, in which the second stage heat transfer fluid heater is a steam boiler (SB) and the generated steam is used as the heating medium in the third stage SHX. The SB is used to generate steam and recover heat from the flue gas from TCR 2. The processes in the embodiment illustrated in FIG. 12 and FIG. 13 are similar to the embodiments illustrated in FIG. 10 and FIG. 11 respectively using thermal oil as heating medium, except that a steam boiler (SB) 23 is placed downstream of TCR 2 instead of a thermal oil heater. The SB and SHX heat transfer loop is the same as the loop described for the embodiment shown in FIG. 2.

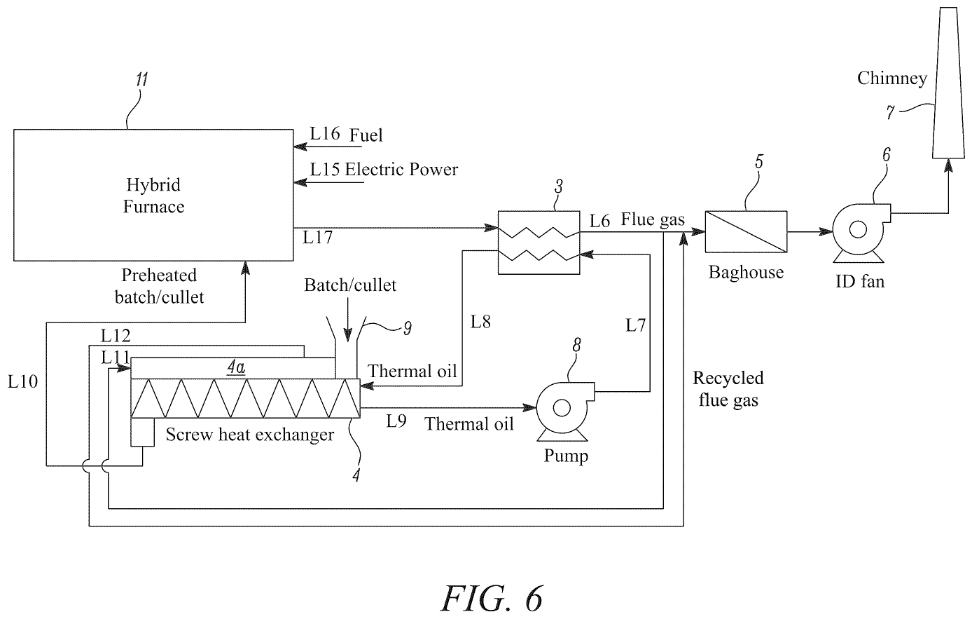

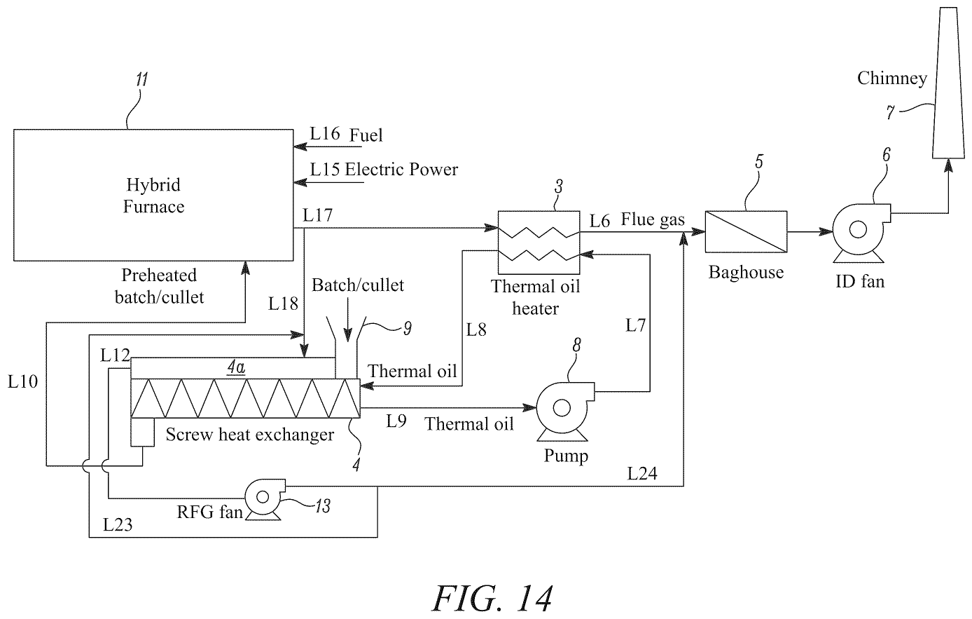

FIG. 14 illustrates an alternative embodiment of the invention similar in configuration to the embodiment shown in FIG. 6. The difference is the flue gas circulation loop for direct heating of the SHX headspace 4a. The flue gas exits the hybrid furnace 11 and 80 to 95% of the flue gas enters thermal oil heater 3 in line L17. A range of 5 to 20% of the flue gas from hybrid furnace 11 is introduced in the head space 4a of the SHX in line L18 to provide additional heat to the batch and cullet in the SHX and to increase the temperature of water vapor evaporated from the batch-cullet mixture to prevent water or acid condensation in the outlet pipe in line L12 from the SHX. Line L12 includes an RFG fan 13 for sending the cooled flue gas in line L24 to combine with line L6 and for treatment in baghouse 5. A portion of the flue gas from RFG fan 13 may be recycled back to the head space 4a of the SHX to control the gas temperature entering the head space 4a as shown by line L23. An alternative method to control the gas temperature entering the head space 4a and the gas temperature entering the thermal oil heater 3 is to recycle a portion of the cooled flue gas from thermal oil heater in line L6 back to the line L17 between the furnace exit and line L18 by using a RFG fan. (not shown)

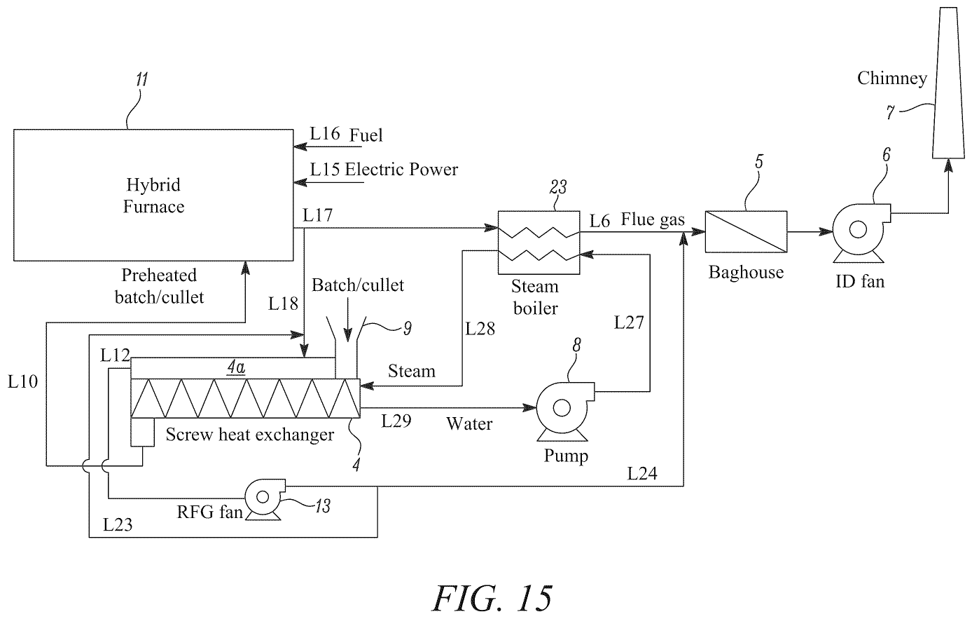

FIG. 15 illustrates an alternative embodiment of the invention shown in FIG. 14. In this embodiment, the second stage heat transfer fluid heater is a steam boiler (SB) in which generated steam is used as the heating medium in the third stage SHX. The SB is used to generate steam and cool down flue gas from hybrid furnace 11. The process in the embodiment illustrated in FIG. 15 is similar to the embodiment illustrated in FIG. 14 using thermal oil as heating medium, except that a steam boiler (SB) 23 is placed downstream of hybrid furnace 11 instead of a thermal oil heater. The SB and SHX heat transfer loop is the same as the loop described for the embodiment shown in FIG. 2.

Secondary heat recovery options for oxy-fuel fired furnaces with TCR include preheating of combustion oxygen and preheating of batch/cullet mixture charged to the furnace. The inventors found the surprising result that more fuel is saved in the furnace by batch/cullet preheating than oxygen preheating when the same amount of energy is recovered from the flue gas for preheating. Specifically, the inventors found that heating and drying of batch and cullet to a modest temperature of 130° C. provides greater energy reduction in the furnace than preheating combustion oxygen to 600° C. This result and other results of the invention are demonstrated in the following glass furnace energy balance model simulation examples.

Table 1 below compares the fuel consumption of an oxy-fuel fired container glass furnace equipped with different fuel reduction systems. The furnace produces 300 tpd of molten glass to make glass bottles using natural gas combustion with oxygen and 1000 kW of electric boost. The charge materials for the glass furnace include batch material comprising silica sand, limestone and soda ash, and cullet (recycled glass) corresponding to 50% of the weight of glass produced. The moisture content of batch material and cullet are 3% and 2% respectively. Fuel is 100% methane, and the oxidant is industrial oxygen containing 92% oxygen.

Case 1 is the baseline example of an oxy-fuel fired furnace without a waste heat recovery system.

Case 2 is an example equipped with a TCR heat recovery system.

Case 3 is an example of the present invention in which the furnace is equipped with TCR, TOH and SHX as illustrated in FIG. 1. Batch and cullet are dried and heated to 130° C. in SHX.

Case 3a is an example of the present invention in which the furnace is equipped with TCR, TOH and SHX as illustrated in FIG. 10. With the supplemental heating using a portion of the flue gas from TCR in the headspace of SHX, batch and cullet are dried and heated to 180° C. in SHX.

Case 3b is an example of the present invention in which the furnace is equipped with TCR, TOH and SHX as illustrated in FIG. 11. With the supplemental heating using a portion of the flue gas from TCR in the headspace of SHX, batch and cullet are dried and heated to 155° C. in SHX.

Case 4 is an example which is equipped with TCR with an oxygen preheater (O2PH) to preheat combustion oxygen to 600° C. with the hot flue gas from the furnace.

Case 5 is an example of the present invention using a hybrid oxy-fuel-electric furnace equipped with TOH and SHX as illustrated in FIG. 5. Flue gas from the hybrid oxy-fuel-electric furnace 11 leaves at 1100° C., containing a flue gas sensible heat of 0.407 GJ/t and enters the thermal oil heater 3 for waste heat recovery. Therminol® 68 as the thermal oil is heated from 300° C. in the heater and the flue gas is cooled to 250° C. in the thermal oil heater 3. The calculated results shown for these examples are based on a glass furnace energy balance model simulation. The model has been well calibrated with commercial container glass furnace operating data and the calculated results are considered to predict actual results. Fuel flow rate, flue gas flow rate, and key operating temperatures are shown for each case.

TABLE 1

| | CASE 1 | CASE 2 | CASE 3 | CASE 3a | CASE 3b | CASE 4 | CASE 5 |
|---|---|---|---|---|---|---|---|
| PRIMARY FLUE GAS HEAT REDUCTION SYSTEM | | TCR | TCR | TCR | TCR | TCR | ELECTRIC |
| SECONDARY HEAT RECOVERY SYSTEM | | | TOH- | TOH- | TOH- | O2PH | TOH-SHX |
| | | | SHX | SHX | SHX | | |
| PREHEAT TEMPERATURE (° C.) | | | 130 | 180 | 155 | 600 | 223 |
| FUEL GAS FLOW RATE (NM3/HR) | 1212 | 999 | 914 | 895 | 902 | 947 | 511 |
| ELECTRIC BOOSTING (KW) | 1000 | 1000 | 1000 | 1000 | 1000 | 1000 | 5000 |
| NET FLUE GAS FLOW RATE (NM3/HR) | 5195 | 4505 | 3775 | 3813 | 4734 | 4337 | 2467 |
| FURNACE GAS EXHAUST TEMPERATURE (° C.) | 1400 | 1410 | 1410 | 1410 | 1410 | 1410 | 1100 |
| TCR EXHAUST TEMPERATURE (° C.) | | 672 | 646 | 550 | 594 | 674 | |
| BCPH/O2PH EXHAUST TEMPERATURE (° C.) | | | 253 | 149 | 299 | 406 | 250 |
| FLUE GAS FLOW RATE TO SHX (NM3/HR) | | | | 878 | 727 | | |
| FUEL (GJ/T) | 3.48 | 2.87 | 2.63 | 2.57 | 2.59 | 2.72 | 1.47 |
| ELECTRIC BOOST (GJ/T) | 0.29 | 0.29 | 0.29 | 0.29 | 0.29 | 0.29 | 1.44 |
| FUEL + ELECTRIC (GJ/T) | 3.77 | 3.16 | 2.91 | 2.86 | 2.88 | 3.01 | 2.91 |
| FUEL REDUCTION VS. OXY (%) | Base | 17.5% | 24.5% | 26.1% | 25.5% | 21.8% | 57.8% |
| (FUEL + ELECTRIC) REDUCTION VS. OXY (%) | Base | 16.2% | 22.7% | 24.1% | 23.6% | 20.1% | 21.8% |
| FUEL REDUCTION VS. TCR (%) | | Base | 8.5% | 10.4% | 9.7% | 5.2% | |

As shown in Table 1, the specific fuel consumption for Case 1 oxy-fuel firing without a heat recovery system is 3.48 GJ/ton of glass (GJ/t). With the TCR heat recovery system in Case 2 the fuel consumption is reduced to 2.87 GJ/t, or by 17.5%. In Cases 3, 3a and 3b the fuel consumption is further reduced to 2.57 to 2.63 GJ/t, or by 24.5 to 26.1% by adding the secondary heat recovery system consisting of TOH and SHX after TCR. Increased fuel savings for Cases 3a and 3b are due to additional heat provided in the headspace of SHX by flue gas from TCR. Batch/cullet preheat temperatures of Cases 3a and 3b are 180° C. and 155° C. respectively as compared to 130 C for Case 3. Case 4 is equipped with TCR and O2PH and fuel consumption is 2.72 GJ/t, or by 21.8% reduction relative to Case 1. Case 5 uses 5000 kW of electric boosting in the furnace to provide about 50% of the furnace heat requirement, which reduces the flue gas flow rate and the heat content. The secondary heat recovery system consisting of TOH and SHX is used to recover the waste heat in the furnace flue gas. Batch and cullet are dried and heated to 223° C. in this case. The fuel consumption is reduced to 1.47 GJ/t or by 57.8%. The total energy consumption of fuel plus electric energy is reduced by 21.8%, which is similar to Case 3. Case 3 and Case 5 show large energy reductions with modest batch and cullet preheat temperatures of 130° C. and 223° C. respectively. The flue gas temperature after the SHX of about 250° C. is considered as full waste heat recovery. By comparison O2PH in Case 4 does not achieve the same energy reduction in spite of heating oxygen to 600° C. The incremental fuel reduction relative to Case 2 TCR baseline shows 8.5% for Case 3 and 5.2% for Case 4.

In Table 2 below, the energy balance of heat recovery by the TOH-SHX system as BCPH (Case 3) and O2PH (Case 4) are compared to explain the reason for the greater fuel savings by using the TOH-SHX system to a modest preheat temperature. The difference of the sensible heat of flue gas entering and leaving TOH and O2PH provides the heat transferred and lost during preheating of batch and cullet and oxygen. Since moisture evaporation requires a large amount of latent heat, more heat is required to preheat batch and cullet. The flow rate of oxygen is proportional to the fuel consumption and reduced as the fuel input is reduced to the furnace. The maximum preheat energy of oxygen is limited by the oxygen flow rate and the preheat temperature of 600° C.

TABLE 2

| | CASE 3 | CASE 4 | CASE 5 |
|---|---|---|---|
| PRIMARY FLUE GAS HEAT REDUCTION SYSTEM | TCR | TCR | ELECTRIC |
| SECONDARY HEAT RECOVERY SYSTEM | TOH-SHX | O2PH | TOH-SHX |
| FLUE GAS SENSIBLE HEAT IN AT TOH/O2PH (GJ/T) | 0.325 | 0.389 | 0.407 |
| FLUE GAS SENSIBLE HEAT OUT AFTER TOH/O2PH (GJ/T) | 0.112 | 0.221 | 0.085 |
| HEAT TRANSFERRED TO THERMAL OIL/O2 (GJ/T) | 0.213 | 0.168 | 0.322 |
| HEAT TRANSFERRED TO BC/O2 (GJ/T) | 0.096 | 0.135 | 0.191 |
| WALL HEAT LOSSES (GJ/T) | 0.042 | 0.034 | 0.056 |
| HEAT LOSS BY MOISTURE EVAPORATION (GJ/T) | 0.075 | | 0.075 |
| FUEL SAVED RELATIVE TO TCR BASELINE (GJ/T) | 0.245 | 0.149 | |
| FUEL SAVED PER 1 GJ TRANSFERRED IN BCPH/O2PH (GJ) | 1.44 | 1.10 | |

As shown in Table 2, the net heat transferred for the moisture evaporation and batch-cullet preheat and the oxygen preheat energy are 0.171 GJ/t (=0.096+0.075) and 0.135 GJ/t for Case 3 and Case 4, respectively. The fuel reductions in the furnace are 0.245 GJ/t and 0.149 GJ/t for Case 3 and Case 4, respectively. The fuel saved divided by the net preheat (PH) energy transferred in the secondary preheater shows the important difference in the efficacy of BCPH. One GJ of heat transferred to remove moisture and to preheat batch/cullet saves 1.44 GJ (LHV) of fuel in Case 3 and 1 GJ of oxygen preheat energy saves 1.10 GJ (LHV) of fuel in Case 4. The greater benefit of the BCPH is due to the removal of water vapor at a low temperature in the BCPH. For the O2PH case, water vapor is heated in the furnace to the flue gas temperature, requiring the additional energy. This surprising result that heating and drying of batch and cullet to a modest temperature of 130° C. provides over 30% greater fuel reduction in the furnace per unit amount of energy required in the preheater than preheating combustion oxygen to 600° C. in the preheater, as described above, provided a basis for the three-stage heat recovery system design using a clean heat transfer fluid. In order to achieve a flue gas temperature of about 250° C. after SHX with batch-cullet preheat temperature of less than 250° C. in the SHX, the flue gas sensible heat content entering TOH is reduced to 0.325 GJ/t by a primary heat exchanger (i.e., TCR) in Case 3 or to 0.407 GJ/t by adding electric energy input in the furnace in Case 5. While it has been shown and described what is considered to be certain embodiments of the invention, it will, of course, be understood that various modifications and changes in form or detail can readily be made without departing from the spirit and scope of the invention. It is, therefore, intended that this invention not be limited to the exact form and detail herein shown and described, nor to anything less than the whole of the invention herein disclosed and hereinafter claimed.

What is claimed is:

1. A flue gas heat recovery system, comprising:
a regenerator configured to receive a flue gas from a glass melting furnace and recover heat from the flue gas;
a heat transfer fluid heater configured to receive flue gas from the regenerator, receive a heat transfer fluid, and transfer heat from the flue gas to the heat transfer fluid; and
a batch/cullet preheater configured to receive the heat transfer fluid from the heat transfer fluid heater, to receive batch and/or cullet, to transfer heat by indirect heat exchange from the heat transfer fluid to the batch and/or cullet; and to recirculate the heat transfer fluid to the heat transfer fluid heater;
wherein the glass melting furnace is configured to receive the batch and/or cullet from the batch/cullet preheater.

2. The flue gas heat recovery system of claim 1, wherein the batch/cullet preheater is a screw heat exchanger.

3. The flue gas heat recovery system of claim 1, wherein the heat transfer fluid heater has a flue gas outlet for flue gas exiting the heat transfer fluid heater,
wherein the batch/cullet preheater has a head space configured to receive a portion of flue gas from the flue gas outlet of the heat transfer fluid heater to provide heat, and
wherein the batch/cullet preheater is configured to return the flue gas after providing heat to the head space of the batch/cullet preheater to the flue gas exiting the flue gas outlet.

4. The flue gas heat recovery system of claim 1, wherein the heat transfer fluid is thermal oil.

5. The flue gas heat recovery system of claim 1, wherein the regenerator is a thermochemical regenerator.

6. The flue gas heat recovery system of claim 1, wherein the batch/cullet preheater has a head space configured to receive a first portion of the flue gas from the regenerator to provide heat, and the heat transfer fluid heater is configured to receive a second portion of flue gas from the regenerator,
wherein the heat transfer fluid heater has a flue gas outlet for flue gas exiting the heat transfer fluid heater, and
wherein the batch/cullet preheater is configured to direct the first portion of the flue gas after providing heat to the head space of the batch/cullet preheater to combine with the flue gas exiting the flue gas outlet of the heat transfer fluid heater.

7. The flue gas heat recovery system of claim 1, wherein the batch/cullet preheater has a head space configured to receive a first portion of the flue gas from the regenerator to provide heat, and the heat transfer fluid heater is configured to receive a second portion of the flue gas from the regenerator,
wherein the batch/cullet preheater is configured to recycle the first portion of the flue gas after providing heat to the head space of the batch/cullet preheater to the regenerator.

8. A method of recovering heat from a flue gas, comprising:
(A) recovering heat from a flue gas from a glass melting furnace in a regenerator for reducing the temperature of the flue gas;
(B) transferring heat from flue gas from the regenerator to a heat transfer fluid in a heat transfer fluid heater;
(C) heating a batch and/or cullet in a batch/cullet preheater by indirect heat exchange using the heat transfer fluid from the heat transfer fluid heater;
(D) recirculating the heat transfer fluid from the batch/cullet preheater to the heat transfer fluid heater; and
(E) feeding the batch and/or cullet from the batch/cullet preheater to the glass melting furnace.

9. The method of recovering heat from a flue gas of claim 8, wherein in step (A), the sensible heat of the flue gas is reduced to less than 0.5 GJ per ton of glass produced in the furnace

10. The method of recovering heat from a flue glass of claim 8, wherein the glass melting furnace is fired with fuel and an oxidant containing greater than 80% oxygen.

11. The method of recovering heat from a flue gas of claim 8, wherein after transferring heat from the flue gas to a heat transfer fluid in the heat transfer fluid heater, flue gas exits the heat transfer fluid heater in a flue gas outlet stream,
wherein the batch/cullet preheater has a head space, and a portion of flue gas from the flue gas outlet of the heat transfer fluid heater enters the head space of the batch/cullet preheater to provide heat, and
after providing heat to the head space of the batch/cullet preheater, the portion of flue gas returns to the flue gas outlet stream.

12. The method of recovering heat from a flue gas of claim 8, wherein the heat transfer fluid is thermal oil.

13. The method of recovering heat from a flue gas of claim 8, wherein after transferring heat from the flue gas to a heat transfer fluid in the heat transfer fluid heater, flue gas exits the heat transfer fluid heater in a flue gas outlet stream, and
wherein the regenerator receives a portion of flue gas from the flue gas outlet stream.

14. The method of recovering heat from a flue gas of claim 8, wherein the batch/cullet preheater has a head space and a first portion of flue gas from the regenerator enters the head space to provide heat, and a second portion of flue gas from the regenerator enters the heat transfer fluid heater,
wherein after transferring heat to a heat transfer fluid in the heat transfer fluid heater, the second portion of flue gas exits the heat transfer fluid heater in a flue gas outlet stream, and
after providing heat to the head space of the batch/cullet preheater, the first portion of flue gas exits the batch/cullet preheater and combines with the flue gas outlet stream of the heat transfer fluid heater.

15. The method of recovering heat from a flue gas of claim 14, wherein the first portion of the flue gas from the regenerator is 5 to 40% of the flue gas from the regenerator, and the second portion of the flue gas is 60 to 95% of the flue gas from the regenerator.

16. The method of recovering heat from a flue gas of claim 8, wherein the batch/cullet preheater has a head space and a first portion of flue gas from the regenerator enters the head space to provide heat, and a second portion of flue gas from the regenerator enters the heat transfer fluid heater,
wherein after providing heat to the head space of the batch/cullet preheater, the first portion of the flue gas is recycled to the regenerator.

17. The method of recovering heat from a flue gas of claim 16, wherein the first portion of the flue gas from the regenerator is 5 to 40% of the flue gas from the regenerator, and the second portion of the flue gas is 60 to 95% of the flue gas from the regenerator.

18. A flue gas heat recovery system, comprising:
a glass melting furnace configured to provide heat by combustion of a fuel and by electric energy to melt glass, and configured to produce a flue gas having a sensible heat of less than 0.5 GJ per ton of the glass produced,
a heat transfer fluid heater configured to receive flue gas from the glass melting furnace, receive a heat transfer fluid, and transfer heat from the flue gas to the heat transfer fluid; and
a batch/cullet preheater configured to receive the heat transfer fluid from the heat transfer fluid heater, to receive batch and/or cullet, to transfer heat by indirect heat exchange from the heat transfer fluid to the batch and/or cullet; and to recirculate the heat transfer fluid to the heat transfer fluid heater;
wherein the glass melting furnace is configured to receive the batch and/or cullet from the batch/cullet preheater.

19. The flue gas heat recovery system of claim 18, wherein the batch/cullet preheater is a screw heat exchanger.

20. The flue gas heat recovery system of claim 18, wherein the heat transfer fluid heater has a flue gas outlet for flue gas exiting the heat transfer fluid heater,
wherein the batch/cullet preheater has a head space configured to receive a portion of flue gas from the flue gas outlet of the heat transfer fluid heater to provide heat, and
wherein the batch/cullet preheater is configured to return the portion of flue gas after providing heat to the head space of the batch/cullet preheater to the flue gas exiting the flue gas outlet.

21. The flue gas heat recovery system of claim 18, wherein the heat transfer fluid is thermal oil.

22. The flue gas heat recovery system of claim 18, wherein the batch/cullet preheater has a head space with a batch/cullet preheater flue gas inlet configured to receive a first portion of flue gas from the glass melting furnace to provide heat, and the heat transfer fluid heater is configured to receive a second portion of flue gas from the glass melting furnace,
wherein the heat transfer fluid heater has a flue gas outlet for flue gas to exit the heat transfer fluid heater,
wherein the batch/cullet preheater has a flue gas outlet for flue gas to exit after providing heat to the head space, and
the batch/cullet preheater is configured to recycle a portion of the flue gas from the batch/cullet preheater flue gas outlet to the batch/cullet preheater flue gas inlet and direct another portion of the flue gas from the batch/cullet preheater flue gas outlet to combine with the flue gas exiting the flue gas outlet of the heat transfer fluid heater.

23. A method of recovering heat from a flue gas, comprising:
(A) melting glass in a glass melting furnace using heat from combustion of fuel and electric energy, and producing a flue gas having a sensible heat of less than 0.5 GJ per ton of the glass melted,
(B) transferring heat from flue gas from the glass melting furnace to a heat transfer fluid in a heat transfer fluid heater;
(C) heating a batch and/or cullet in a batch/cullet preheater by indirect heat exchange using the heat transfer fluid from the heat transfer fluid heater;
(D) recirculating the heat transfer fluid from the batch/cullet preheater to the heat transfer fluid heater; and
(E) feeding the batch and/or cullet from the batch/cullet preheater to the glass melting furnace.

24. The method of recovering heat from a flue gas of claim 23, wherein the glass melting furnace receives an input of electrical energy of 40% or more of the total energy input to the glass melting furnace, wherein the total energy input is the sum of a lower heating value of the fuel input and the electric energy input

25. The method of recovering heat from a flue gas of claim 23, wherein after transferring heat from the flue gas to a heat transfer fluid in the heat transfer fluid heater, flue gas exits the heat transfer fluid heater in a flue gas outlet stream,
wherein the batch/cullet preheater has a head space, and a portion of the flue gas in the flue gas outlet stream enters the head space of the batch/cullet preheater to provide heat, and
after providing heat to the head space of the batch/cullet preheater, the portion of flue gas returns to the flue gas outlet stream.

26. The method of recovering heat from a flue gas of claim 23, wherein the heat transfer fluid is thermal oil.

27. The method of recovering heat from a flue gas of claim 23, wherein the batch/cullet preheater has a head space and a first portion of flue gas from the glass melting furnace enters the head space to provide heat, and a second portion of flue gas from the glass melting furnace enters the heat transfer fluid heater,
wherein after transferring heat to a heat transfer fluid in the heat transfer fluid heater, the second portion of flue gas exits the heat transfer fluid heater in a flue gas outlet stream, and
after providing heat to the head space of the batch/cullet preheater, the first portion of flue gas exits the batch/cullet preheater, a portion of which is recycled back to the head space and another portion combines with the flue gas outlet stream of the heat transfer fluid heater.

28. The method of recovering heat from a flue gas of claim 27, wherein the first portion of the flue gas from the glass melting furnace is 5 to 20% of the flue gas from the glass melting furnace, and the second portion of the flue gas is 80 to 95% of the flue gas from the flue gas melting furnace.
